(19) United States
(12) Patent Application Publication
(10) Pub. No.: US 2012/0154833 A1
(43) Pub. Date: Jun. 21, 2012

(54) IMAGE DISPLAY APPARATUS, IMAGE CONTROL METHOD FOR IMAGE DISPLAY APPARATUS, AND STORAGE MEDIUM

(75) Inventor: Motoki Ikeda, Tokyo (JP)

(73) Assignee: CANON KABUSHIKI KAISHA, Tokyo (JP)

(21) Appl. No.: 13/316,210

(22) Filed: Dec. 9, 2011

(30) Foreign Application Priority Data
Dec. 15, 2010 (JP) 2010-279668

(51) Int. Cl. H04N 1/60

(52) U.S. Cl. 358/1.9

(57) ABSTRACT

There is provided an apparatus and a method for displaying display patterns of respective regions on a preview image, changed according to an applied amount of transparent toner. A control method for controlling an image display apparatus includes displaying on a display unit a preview of an image to be printed using a printing unit, setting a region in which the printing unit performs printing using transparent toner with respect to an image previewed on the display unit, and a transparent toner amount applied on the region, and changing a preview display pattern of an image to be displayed on the display unit, using the set region to be printed therein with the transparent toner and the transparent toner amount.

### BACKGROUND OF THE INVENTION

1. Field of the Invention

The present invention generally relates to imaging and more particularly to an image display apparatus for previewing an image to be printed, a control method for the image display apparatus, and a storage medium.

2. Description of the Related Art

In the field of digital printing technique, not only conventional full-color printing by electrophotographic printing using four-color toners of Cyan Magenta Yellow Black (CMYBk), but also a printing system using special toner is gathering attention. As an example of special toner, transparent toner is available.

The transparent toner has various applications. For example, the following applications can be named. The transparent toner absorbs irregularities on the surface of a printing paper and gives gloss feel to printing products. On the other hand, the transparent toner provides colorless watermarks on the printing products as a convex portion. To allow a user to easily turn over pages with fingers, paper end portion is printed using the transparent toner to form convex portions, which are used as an anti-slip.

As for the watermarks, copy-forgery-inhibited pattern technique is conventionally available. In this technique, there is a problem that, even when displaying a preview of an image obtained by scanning a document, on which forgery-inhibited pattern has been printed, the user cannot make visual identification of existence of the copy-forgery-inhibited pattern.

To deal with this problem, a technique for highlighting and displaying the copy-forgery-inhibited pattern portion on a preview image, according to density of the copy-forgery-inhibited pattern is discussed, for example, in Japanese Patent Application Laid-Open NO 2009-39997. Herein, the density of the copy-forgery-inhibited pattern refers to a number of printed dots of consumed toner per unit area. According to this technique, the user can recognize existence of the copy-forgery-inhibited pattern and its density by a display of the preview image, with regard to the copy-forgery-inhibited pattern.

However, when an image is printed using the transparent toner, the user cannot recognize by watching a preview image how much amount of the transparent toner will be applied on a sheet. For this reason, for example, the user is supposed to recognize difference of gloss feel or difference of irregularity feel of respective regions on the paper printed using the transparent toner, only after printing is carried out. Then, the user, when finding the least desired results, needs to perform the settings relating to the transparent toner again, and perform printing.

### SUMMARY OF THE INVENTION

According to an aspect of the present invention, an image display apparatus includes a display unit configured to display a preview of an image to be printed using a printing unit, a setting unit configured to set a region in which the printing unit prints using transparent toner with respect to an image previewed on the display unit, and a transparent toner amount to be applied on the region, and a control unit configured to change a preview display pattern of an image which the display unit displays, using the region set by the setting unit and the transparent toner amount.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a schematic configuration of an image forming apparatus including an image display apparatus.

FIG. 2 is a configuration diagram illustrating contents of settings relating to printing of transparent toner used in a printing device.

FIG. 3 illustrates a screen displayed on a user interface illustrated in FIG. 1.

FIG. 4 is a flowchart illustrating a control procedure of the image display apparatus.

FIG. 5A, 5B, and 5C each illustrate screens displayed on the user interface illustrated in FIG. 1.

FIG. 6 is a flowchart illustrating a control procedure of the image display apparatus.

FIG. 7 is a flowchart illustrating a control procedure of the image display apparatus.

FIG. 8 illustrates a screen displayed on the user interface illustrated in FIG. 1.

FIG. 9 illustrates a screen displayed on the user interface illustrated in FIG. 1.

FIG. 10 is a flowchart illustrating a control procedure of the image display apparatus according to an exemplary embodiment.

### DESCRIPTION OF THE EMBODIMENTS

Various exemplary embodiments, features, and aspects of the invention will be described in detail below with reference to the drawings.

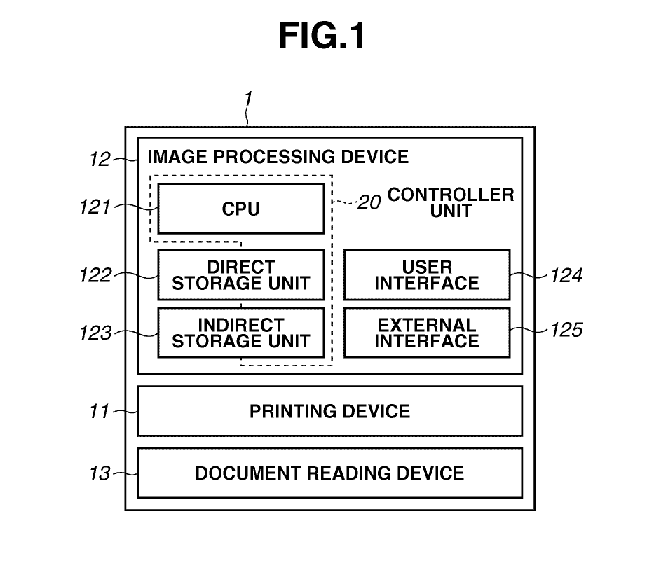

Next, an exemplary embodiment of the present invention will be described below with reference to the drawings. FIG. 1 is a block diagram illustrating a schematic configuration of an image forming apparatus including an image display apparatus according to the present exemplary embodiment. The present exemplary embodiment is described exemplifying an image forming apparatus as an example, which can execute image forming processing using the transparent toner other than, for example, four color toners.

In FIG. 1, an image forming apparatus 1 includes a printing device 11 and an image processing device 12, and a document reading device 13. The document reading device 13 inputs a reflected light obtained by exposing to light and scanning an image on the original document into a charge-coupled device (CCD) so as to convert information of the image into an electrical signal. The document reading device 13, further, converts the electrical signal into a luminance signal including R (red), G (green), and B (blue) colors, and outputs the luminance signal to the image processing device 12 as image data.

The image processing device 12 includes a central processing unit (CPU) 121, a direct storage unit 122 (e.g., a random-access memory (RAM)), an indirect storage unit 123 (e.g., a hard disk drive (HDD)), a user interface 124, and an external interface 125. The direct storage unit 122 is a storage unit which directly exchanges data with the CPU 121, and the indirect storage unit 123 is a storage unit which exchanges data with the CPU 121 via the direct storage unit 122.

The indirect storage unit 123 stores therein a controller programs for controlling the image forming apparatus 1. Further, the direct storage unit 122 temporarily stores therein information obtained, for example, when the CPU 121 executes the controller programs.

The user interface 124 includes a touch panel and a keyboard, a mouse, and a display, and enables acceptance of designation from a user, display of data (display data) to be performed. In subsequent descriptions, an operation that the user interface 124 outputs the display data to the display is written as the user interface 124 “displays”.

The external interface 125 enables reception of data from external apparatuses and transmission of data to the external apparatuses. For example, the external apparatuses include external storage devices such as an external HDD, an external universal serial bus (USB) memory, etc., and separate apparatuses such as separate host computers, image forming apparatuses, etc. connected via a network.

The image processing device 12 receives image data from the document reading device 13 or separate apparatuses (via the external interface), under control of a controller unit 20 described below. Then, the image processing device 12 electrically processes the image data to decompose the image data into respective components of cyan (C), magenta (M), yellow (Y), and black (Bk), and outputs them to the printing device 11 as an image signal with predetermined bits. Further, the image processing device 12 forms an image for printing using the transparent toner, and outputs the image to the printing device 11.

The printing device 11 prints and outputs a color image or monochrome image on a sheet by using the respective C, M, Y, and Bk toners according to the image data generated by the image processing device 12. In the present exemplary embodiment, the printing device 11 is a printing device of an electrophotographic printing system. Further, the printing device 11 according to the present exemplary embodiment contains therein the transparent toner, and performs printing processing using the transparent toner on the paper in accordance with the print condition to be set.

The CPU 121 can move (store) a controller program stored in the indirect storage unit 123 to the direct storage unit 122. The CPU 121, when movement of the controller program is completed, goes into a state where the CPU 121 can execute the controller program.

In the present exemplary embodiment, the combination of the following configurations is referred to as a controller unit 20. That is, the controller unit 20 is composed of the CPU 121, a region where the controller program is stored within the direct storage unit 122, and a region where information obtained when the CPU 121 processes the controller program, is stored. Herein, these regions correspond to regions within the direct storage unit 122 and the indirect storage unit 123.

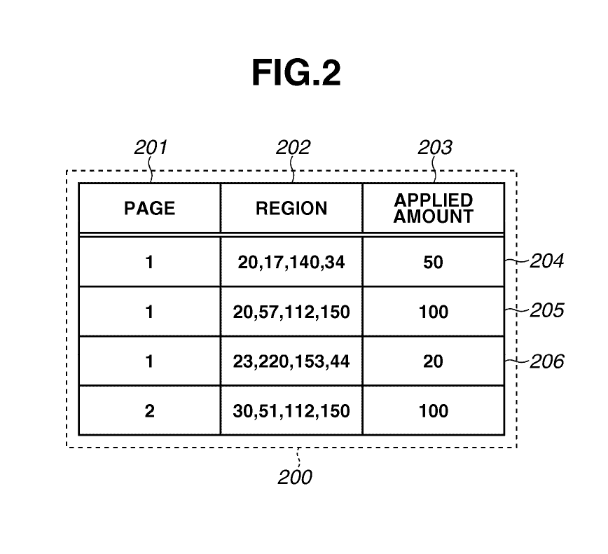

FIG. 2 is a configuration diagram illustrating contents of settings relating to printing of the transparent toner to be used in the printing device 11 illustrated in FIG. 1. In FIG. 2, a transparent toner print setting 200 is managed and stored by the controller unit 20 by using the direct storage unit 122.

One record (row) in the transparent toner print setting 200 represents one region to be printed therein using the transparent toner. A page data item 201 is a data item indicating a page number of the image. A region data item 202 is a data item which indicates a region to be printed therein using the transparent toner, at a page indicated in the page data item 201 of the image.

The region data item 202 is coordinate values having an origin at a top-left corner of the page, and is data including an X-coordinate value, a Y-coordinate value, a width, and a height each separated with commas (,). The X-coordinate and Y-coordinate of the page data itself are assumed to be greater than the values of coordinates indicated in the region data item 202, and the region data item 202 is assumed to indicate X-coordinate, and Y-coordinate of a portion of the region included in the page data.

An applied amount data item 203 is a data item indicating an applied amount of the transparent toner to be printed in the region indicated by the region data item 202. The applied amount data item 203 stores therein a value indicating the applied amount of the transparent toner. This value is 0 or more and equal to or less than a maximum value of the applied amount, wherein the maximum value of the applied amount depends on a configuration of the printing device 11.

As described above, the controller unit 20 decomposes an image composed of the respective colors of R, G, and B into the respective components of C, M, Y, and Bk, and outputs them to the printing device 11 as an image signal.

Further, the controller unit 20 refers to the transparent toner print setting 200 illustrated in FIG. 2, and when printing of the transparent toner is set, generates an image for printing the transparent toner according to the setting, and outputs the data to the printing device 11.

The printing device 11, in its image forming process, forms an image signal composed of the above-described CMYBk as an image on the paper. Subsequently to the processing, when an image for printing the transparent toner is output from the image processing device 12, the printing device 11 is controlled to perform printing using the transparent toner again through the image forming process without discharging the sheet. In other words, the printing device 12 performs printing using the transparent toner, in the second image forming process.

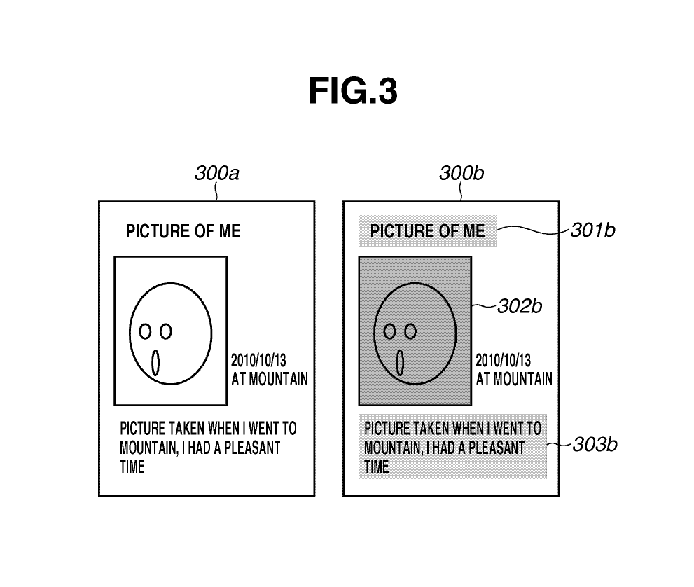

FIG. 3 illustrates a screen displayed by the user interface 124 illustrated in FIG. 1. This example is a screen example illustrating display data displayed by the user interface 124 illustrated in FIG. 1 as a (normal) preview image.

In FIG. 3, print data 300a includes texts and an image. The print data is printed by the printing device 11 using respective CMYBk color toners.

The user interface 124, upon accepting a preview display instruction from the user, notifies the controller unit 20 accordingly. The controller unit 20 generates a preview image from an image which the document reading device 13 has read out, or image data which the external interface 125 has received from an external apparatus.

The image data which the image forming apparatus 1 handles has a considerably higher resolution, compared with that of a display device such as a display in the user interface 124. For this reason, the preview image is generated with a lower resolution than that of the image. Then, the controller unit 20 generates display data from the above-described generated preview image.

Further, the controller unit 20, in a case where the image data constituting a generation source of the preview image is composed of a plurality of pages, stores page numbers at which the preview image is generated as a current page. In subsequent descriptions, an image constituting the generation source of the preview image is simply referred to as “image”.

In FIG. 3, the user interface 124 displays a display data 300b as a preview image of an applied amount of transparent toner.

The user interface 124, upon accepting a preview display instruction of the applied amount of transparent toner from the user, notifies the controller unit 20 accordingly. The controller unit 20 generates a preview image of the applied amount of transparent toner, based on information stored in the transparent toner print setting 200.

Then, the controller unit 20 generates display data from the preview image of the applied amount of transparent toner, and outputs the display data to the user interface 124. In the applied amount preview image of the transparent toner, a region to be printed therein using the transparent toner and its applied amount are expressed as a rectangle of yellow (R:240, G:240, B:100) for which a value (transmittance) calculated according to the applied amount has been set, on a (normal) preview image. The transparent toner applied amount preview image is an image obtained by a combination of a preview image and a yellow rectangle for which a value has been set.

A region 301b corresponds to a record 204 of the transparent toner print setting 200. A region 302b corresponds to a record 205 of the transparent toner print setting 200. A region 303b corresponds to a record 206 of the transparent toner print setting 200.

In the subsequent descriptions, a preview image of the applied amount of the transparent toner is referred to as “transparent toner applied amount preview image”. In contrast with the transparent toner applied amount preview image, the (normal) preview image is simply referred to as “a preview image”.

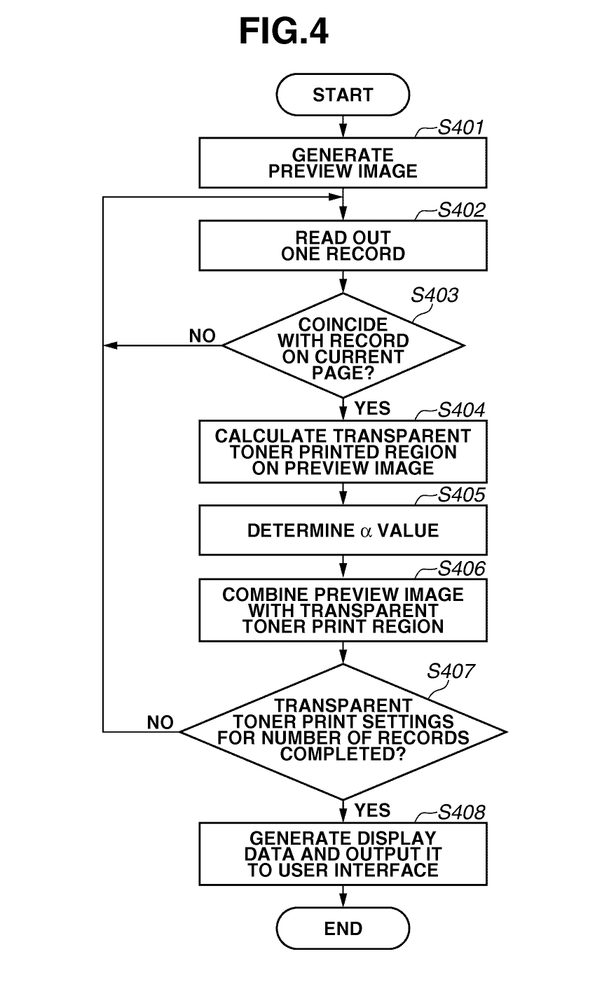

FIG. 4 is a flowchart illustrating a control procedure of the image display apparatus according to the present exemplary embodiment. This example is processing procedure when the controller unit 20 generates display data to be displayed on the user interface 124 as the transparent toner applied amount preview image. Respective steps are realized by loading a control program onto the direct storage unit 122 and executing it by the CPU 121 of the controller unit 20 illustrated in FIG. 1.

Hereinbelow, a print region display of the transparent toner image to be printed therein by the printing device 11 using the controller unit 20 and the user interface 124 will be described. The user interface 124 displays a region where the printing device 11 prints using the transparent toner with respect to an image to be previewed, and a setting screen for setting a transparent toner amount to be applied on the region.

At this time, by executing the processing described below, the user interface 124 accepts a region to be printed therein using the transparent toner and the transparent toner amount to be set by the user using, for example, the touch panel, and notifies the controller unit 20 accordingly.

Then, the user interface 124 displays a transparent toner region to be printed therein using a transmittance a calculated by the controller unit 20. In other words, the user interface 124 changes a preview display pattern of a region where an image previewed by executing the processing described below is printed using the transparent toner.

In step S401, the controller unit 20 generates a preview image 300a illustrated in FIG. 3A. Next, in step S402, the controller unit 20 reads one record from the transparent toner print setting 200 stored in the direct storage unit 122.

Then, in step S403, the controller unit 20 determine whether the page data item 201 of the record read out in step S402 coincides with a page of a preview image currently being displayed, by using the user interface 124. If the controller unit 20 determines that the page data item 201 of the record coincides with the page of the preview image (YES in step S403), the processing proceeds to step S404. If the controller unit 20 determines that the page data item 201 of the record does not coincide with the page of the preview image (NO in step S403), the processing returns to step S402.

Then, in step S404, the controller unit 20 calculates a region on the preview image, with regard to the region indicated by the region data item 202 of the record read out in step S402. This is obtained by calculation based on a resolution when the controller unit 20 generates a preview image from the image.

Next, in step S405, the controller unit 20 determines a value from the applied amount data item 203 of the record read out in step S402. The a value is numerical value in a range of “0 to 255”, the closer to “0” the lower the transparency becomes, and the closer to “255”, the higher the transparency becomes (for example, in a case of 0, an image becomes opaque, in a case of 255, the image becomes transparent). The a value is determined by the controller unit 20 using the following formula (1).

α value=(minimum α value−255)/maximum value of applied amount×applied amount+255 (1)

With regard to a minimum α value in the above-described formula (1), a minimum value of α value is provided so that appearance of a region of the original preview image can be seen, when a yellow rectangle for which a value has been set is combined on the preview image.

Next, in step S406, the controller unit 20 combines the region portion calculated in step S405 on the preview image with a yellow rectangle for which α value determined in step S405 has been set.

Next, in step S407, the controller unit 20 determines whether the processing in steps S402 to S406 have been repeated, for the number of records registered in the transparent toner print setting 200. If the controller unit 20 determines that the processing in steps S402 to S406 have not been repeated, for the number of records registered on the transparent toner print setting 200 (NO in step S407), the processing returns to step S402, and repeats the same processing.

On the other hand, if the controller unit 20 determines that the processing in steps S402 to S406 have been repeated, for the number of records registered on the transparent toner print setting 200 (YES in step 407), the processing proceeds to step S408. When the processing in step S402 to step S407 are completed, the generation processing of the transparent toner applied amount preview image is completed.

Then, in step S408, the controller unit 20 generates display data from the generated transparent toner applied amount preview image, outputs the display data to the user interface 124, and ends the present processing.

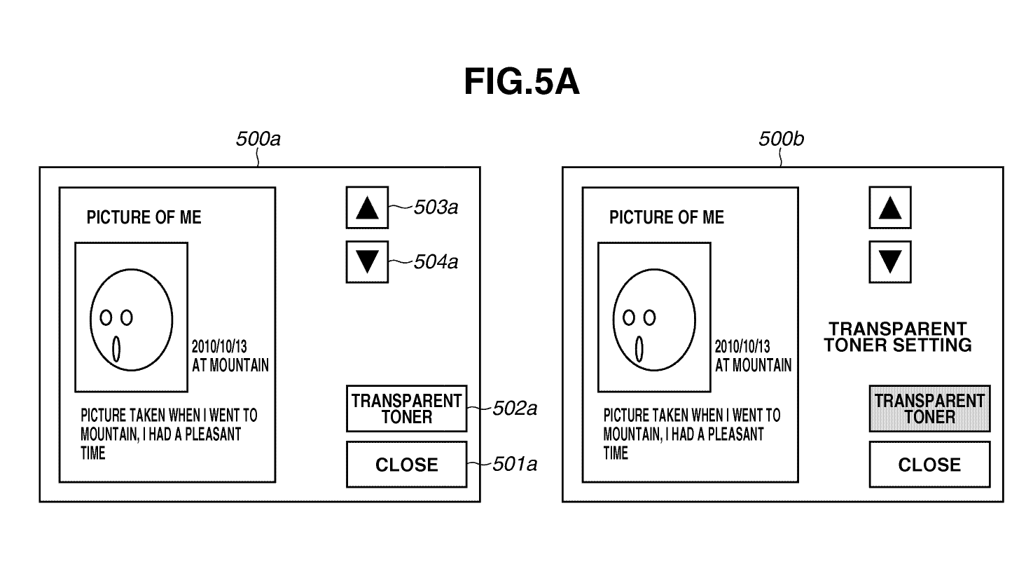

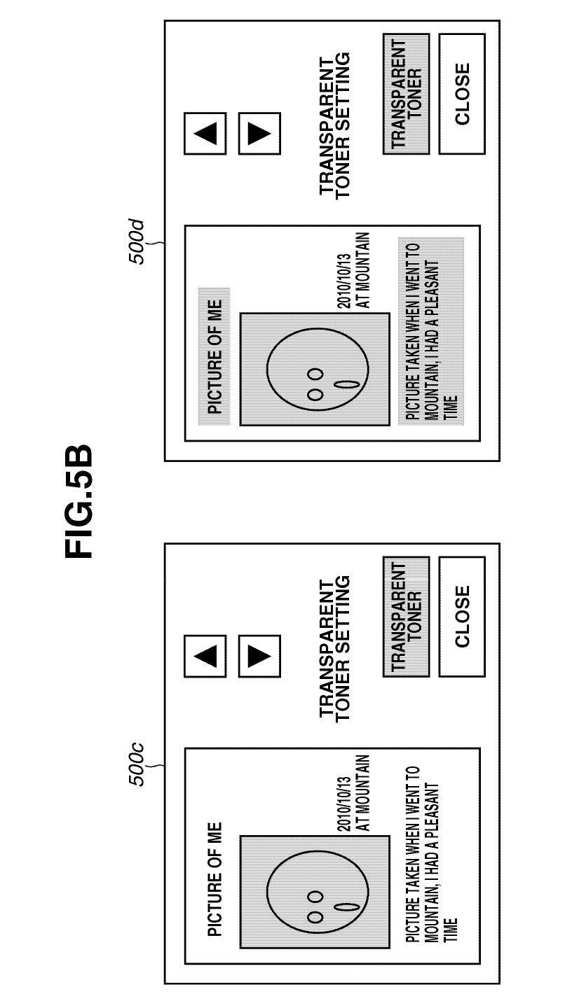

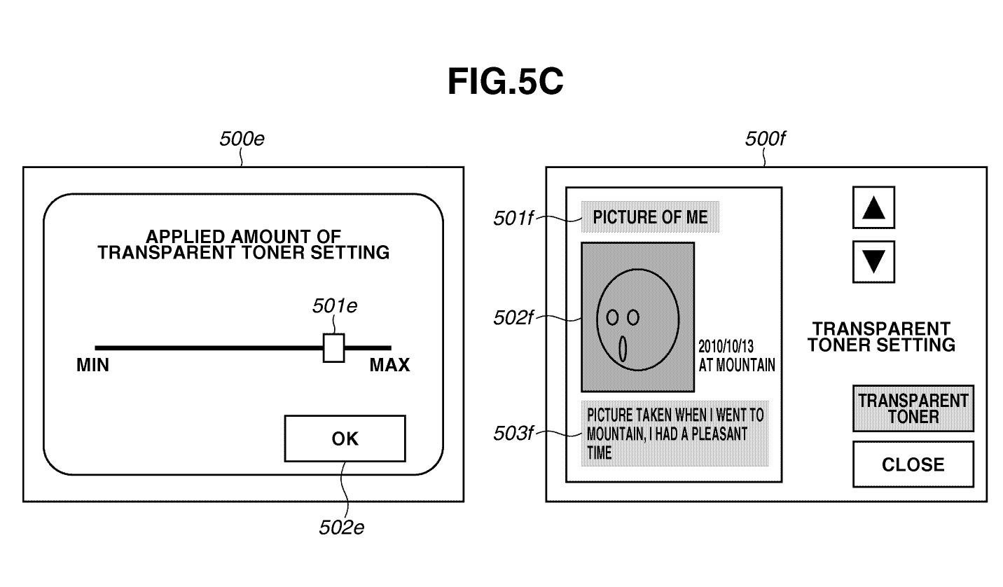

FIG. 5A to 5C each illustrate a screen displayed on the user interface 124 illustrated in FIG. 1. Hereinbelow, setting of transparent toner region on the preview screen and change of display pattern will be described.

In FIG. 5A, a screen 500a is a screen that displays a preview image. A button 501a is a button for ending display of the preview image. When a user designates the button 501a, the user interface 124 ends display of the preview image and displays another screen (e.g., a screen for setting of printing, not illustrated).

A button 502a is a button that designates display of the transparent toner print preview. When the user designates the button 502a, the user interface 124 displays a screen illustrated on a screen 500b in FIG. 5A. A button 503a and a button 504a are used to change the page for preview display, when an image has a plurality of pages.

The screen 500b in FIG. 5A is a screen that displays the transparent toner applied amount preview (a region to be printed therein with the transparent toner has not yet been set). On this screen, the user, while referring to the transparent toner applied amount preview, sets a region to be printed therein with the transparent toner and the applied amount of the transparent toner in the region. By designating arbitrary two points included in a preview image portion within the screen 500b, the user performs setting of a region to be printed therein with the transparent toner.

The controller unit 20 interprets the designated two points as a rectangle defined by a top-left corner and a bottom-right corner, and sets the rectangle based on the designated two-points as a region to be printed therein with the transparent toner.

At this time, the applied amount of the transparent toner to be printed in the region is taken as an intermediate value (calculated based on a maximum value of the applied amount/2), which is a default value. When a region to be printed therein with the transparent toner is set, the user interface 124 displays a screen 500c in FIG. 5B.

The screen 500c in FIG. 5B is a screen that displays the transparent toner applied amount preview, and one region to be printed therein with the transparent toner is set. By repeating the above-described operations, regions to be printed therein with the transparent toner can be added one after another, and thereby a plurality of settings can be performed.

A screen 500d in FIG. 5B is a screen that displays a transparent toner applied amount preview, and illustrates a case where a plurality of (three) regions to be printed therein with the transparent toner are set (in any region, an applied amount of the transparent toner is an intermediate value, which is a default value).

On screen 500c or screen 500d, when a region to be printed therein with the transparent toner is set, the user interface 124 displays a screen 500e in FIG. 5C, when a portion corresponding to any one of the regions to be printed therein with the transparent toner is designated.

The screen 500e in FIG. 5C is a screen for setting an applied amount of the transparent toner. A knob 501e is a knob used for changing the applied amount of the transparent toner. When a user performs instruction to move the knob 501e to the right side, the controller unit 20 increases the applied amount of the transparent toner of the region.

When a user performs instruction to move the knob 501e to the right side end, the controller unit 20 sets the applied amount of the transparent toner of the region to the maximum.

In addition, when a user performs instruction to move the knob 501e to the left side, the controller unit 20 decreases the applied amount of the transparent toner of the region. Furthermore, when the user performs instruction to move the knob 501e to left side end, the applied amount of the transparent toner of the region becomes zero, and a preview of the transparent toner with respect to the region is ended.

A button 502e is a button for designating a final applied amount setting of the transparent toner. When the user designates the button 502e, the controller unit 20 determines the applied amount setting of the transparent toner, and the screen returns to a screen (a screen 500f in FIG. 5C) that displays the transparent toner applied amount preview.

Further, the screen 500f is a screen that displays the transparent toner applied amount preview, and is a screen in a case where the applied amount of the transparent toner is changed from the screen 500e.

The present screen example illustrates a case where three regions to be printed therein with the transparent toner are set, and the applied amounts of the transparent toner of the respective regions are set in descending order of a region 502f, a region 501f, and a region 503f.

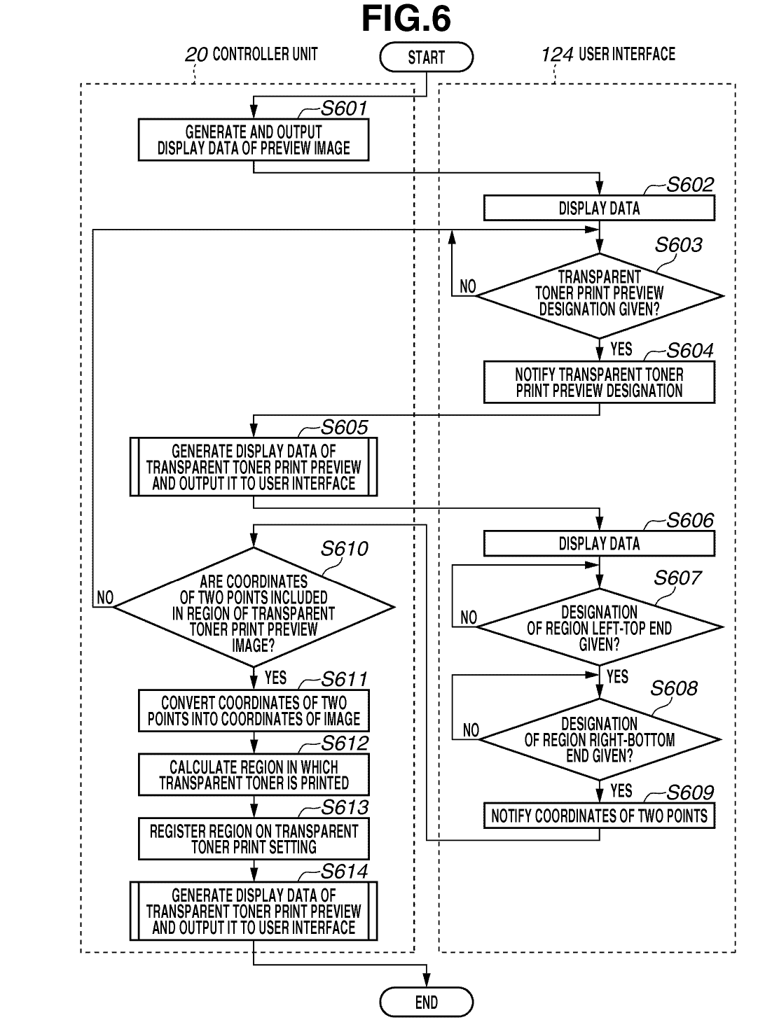

FIG. 6 is a flowchart illustrating a control procedure of the image display apparatus according to the present exemplary embodiment. The flowchart illustrates processing procedures of the controller unit 20 and the user interface 124, when a region to be printed therein with the transparent toner is set. Respective steps are realized by loading a control program onto the direct storage unit 122 and executing it by the CPU 121 of the controller unit 20 illustrated in FIG. 1.

First, in step S601, the controller unit 20 generates and outputs a preview image and its display data to the user interface 124. In step S602, the user interface 124 displays the display data output from the controller unit 20 in step S601. Accordingly, the user interface 124 displays the screen 500a in FIG. 5A.

Then, instep S603, the user interface 124 determines whether the transparent toner print preview instruction has been given from the user. The transparent toner print preview instruction from the user is received by the user's designation via the button 502a.

If the user interface 124 determines that the transparent toner print preview instruction has been given from the user (YES in step S603), the processing proceeds to step S604. If the user interface 124 determines that the transparent toner print preview instruction has not been given (NO in step S603), the user interface 124 repeats the processing in step S603. Next, in step S604, the user interface 124 notifies the controller unit 20 of transparent toner print preview instruction received from the user.

Then, the controller unit 20 executes the processing procedure illustrated in FIG. 4, and generates a transparent toner print preview image and its display data. Then, in step S605, the controller unit 20 outputs the display data to the user interface 124. At this time, the controller unit 20 stores on the direct storage unit 122 the position of the transparent toner print preview image in the display data.

Then, in step S606, the user interface 124 displays the display data output from the controller unit 20 in step S605. Accordingly, the user interface 124 displays the screen 500b in FIG. 5A.

Next, in step S607, the user interface 124 determines whether designation of the print region (region top-left corner) to be printed therein with the transparent toner has been given from the user. If the user interface 124 determines that designation of print region (region top-left corner) to be printed therein with the transparent toner has been given from the user (YES in step S607), the processing proceeds to step S608. If the user interface 124 determines that designation of print region has not been given (NO in step S607), the user interface 124 repeats the processing in step S607.

Then, instep S608, the user interface 124 determines whether designation of the print region (region bottom-right corner) to be printed therein with the transparent toner has been given from the user. If the user interface 124 determines that designation of the print region (region bottom-right corner) to be printed therein with the transparent toner has been given from the user (YES in step S608), the processing proceeds to step S609. If the user interface 124 determines that designation of print region has not been given (NO in step S608), the user interface 124 repeats the processing in step S608.

Then, in step S609, the user interface 124 notifies the controller unit 20 of coordinates (coordinates on display data) of two points received in steps S607 and S608.

In step S610, the controller unit 20 determines whether the received coordinates of the two points are included in a region corresponding to the transparent toner print preview image among the display data. This determination can be made by the controller unit 20 from the position of the transparent toner print preview image in the display data stored in the direct storage unit 122 in step S605.

If the controller unit 20 determines that the coordinates of the two points are included in the region of the transparent toner print preview image (YES in step S610), the processing proceeds to step S611. If the controller unit 20 determines that the coordinates of the two points are not included or any one of them is not included in the transparent toner print preview image (NO in step S610), the processing returns to step S603.

Then, in step S611, the controller unit 20 converts the coordinates of the two points notified in step S609 into coordinates having a base point located at a top-left corner of the image. This conversion can be performed based on the resolution when the controller unit 20 generates the preview image.

Next, in step S612, the controller unit 20, from the converted coordinates of the two points, calculates a rectangle defined by the top-left corner and the bottom-right corner positioned at these points, as a region to be printed therein with the transparent toner. The controller unit 20 compares the X-positions of coordinate data of the two points, and takes the coordinate data closer to the origin (top-left corner of the image) as the top-left corner, and the other coordinate data as the bottom-right corner.

Then, the controller unit 20 obtains a width of the rectangle by subtracting the X-position of the top-left corner from the X-position of the bottom-right corner. Further, the controller unit 20 obtains a height of the rectangle by subtracting the Y-coordinate of the top-left corner from the Y-coordinate of the bottom-right corner.

Next, in step S613, the controller unit 20 registers on the transparent toner print setting 200 the region to be printed therein with the transparent toner calculated in step S612. The controller unit 20 adds one record to the transparent toner print setting 200, and stores the data in respective data items as follows.

The controller unit 20 stores the current page stored by the controller unit 20 in the page data item 201. The controller unit 20 stores in the region data item 202 the region to be printed therein with the transparent toner calculated in step S612.

Further, the controller unit 20 stores an intermediate value (calculated based on the applied amount maximum value/2) in the applied amount data item 203, as the applied amount of the transparent toner.

Next, in step S614, the controller unit 20 executes the processing illustrated in FIG. 4 to generate a transparent toner applied amount preview image and its display data, outputs them to the user interface 124, and ends the present processing.

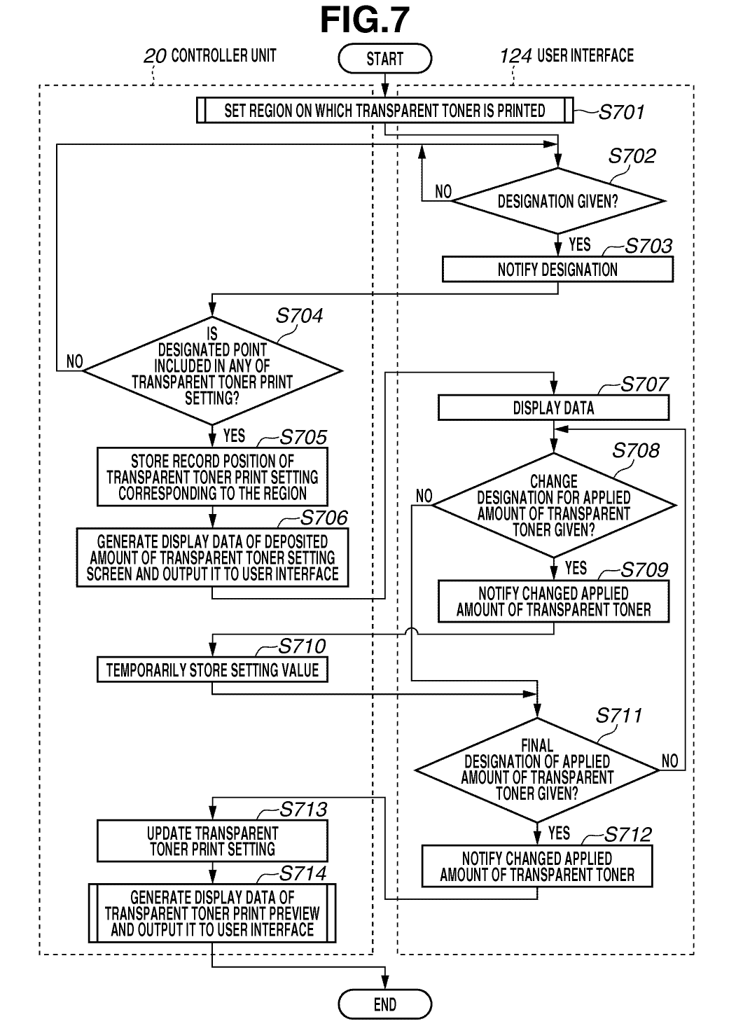

FIG. 7 is a flowchart illustrating a control procedure of the image display apparatus according to the present exemplary embodiment. This flowchart illustrates processing procedures of the controller unit 20 and the user interface 124, when an applied amount of the transparent toner is set. Respective steps are realized by loading a control program onto the direct storage unit 122 and executing it by the CPU 121 of the controller unit 20 illustrated in FIG. 1.

First, in step S701, the controller unit 20 and the user interface 124 execute the processing illustrated in FIG. 6 to set the region to be printed therein with the transparent toner, and display the display data of the transparent toner print preview image.

Next, in step S702, the user interface 124 determines whether designation of the applied amount setting of the transparent toner has been given by the user. In this case, the designation of the applied amount setting of the transparent toner means, for example, a designation of the region 501f, the region 502f, or the region 503f on the screen 500f. If the user interface 124 determines that the designation of the applied amount setting of the transparent toner has been given by the user (YES in step S702), the processing proceeds to step S703. If the user interface 124 determines that the designation of the applied amount setting of the transparent toner has not been given (NO in step S702), the user interface 124 repeats the processing in step S702.

Then, in step S703, the user interface 124 notifies the controller unit 20 of the designation (designation of the applied amount setting of the transparent toner). At this time, the user interface 124 notifies the controller unit 20 of the coordinates of the designated location (point) on the display data.

Next, in step S704, the controller unit 20 determines whether the designated points are included in any region to be printed therein with the transparent toner previously set. To this end, first, the controller unit 20 converts the coordinates notified in step S703 into coordinates on the image.

Then, in step S704, the controller unit 20, with regard to the coordinates after conversion, determines whether they are included in the region data item 202 of the respective records of the transparent toner print setting 200, and determines presence or absence of the corresponding record. If the controller unit 20 determines that the corresponding record is present (YES in step S704), the processing proceeds to step S705. On the other hand, if the controller unit 20 determines that a matching record is not present (NO in step S704), the processing returns to step S702.

Then, in step S705, the controller unit 20 stores the position of the identified record on the direct storage unit 122. Next, in step S706, the controller unit 20 generates display data of the applied amount of transparent toner setting screen according to values of the applied amount data item 203 stored in the records identified in step S704, and outputs it to the user interface 124.

Then, in step S707, the user interface 124 displays the display data output from the controller unit 20 in step S706 as the screen 500e in FIG. 5C.

Next, in step S708, the user interface 124 determines whether a change designation of the applied amount of the transparent toner has been given from an operation of the knob 501e performed by the user. If the user interface 124 determines that the change designation of the applied amount of the transparent toner has been given (YES in step S708), the processing proceeds to step S709. If the user interface 124 determines that the change designation of the applied amount has not been given (NO in step S708), the processing proceeds to step S711.

Then, in step S709, the user interface 124 notifies the controller unit 20 of the changed applied amount of the transparent toner. Next, in step S710, the controller unit 20 temporarily stores on the direct storage unit 122 the applied amount of the transparent toner notified from the user interface 124 in step S709.

Next, in step S711, the user interface 124 determines whether a final designation of the applied amount setting of the transparent toner has been given by the user operating the button 502e. If the user interface 124 determines that the designation of the button 502e has been given (YES in step S711), the processing proceeds to step S712. If the user interface 124 determines that the designation of the button 502e has not been given (NO in step S711), the processing returns to step S708.

Next, in step S712, the user interface 124 notifies the controller unit 20 of the final designation of the applied amount setting of the transparent toner. Then, in step S713, the controller unit 20, upon being notified of the final designation of the applied amount setting of the transparent toner from the user interface 124, updates the transparent toner print setting 200.

Then, the controller unit 20 updates the applied amount data item 203 of the record of the transparent toner print setting 200 corresponding to the position stored on the direct storage unit 122 in step S705 with the applied amount of the transparent toner stored in step S710. At this time, if a value of the stored applied amount is zero, the record is deleted from the transparent toner print setting 200.

Then, in step S714, the controller unit 20 executes the processing illustrated in FIG. 4 to generate the transparent toner applied amount preview image and its display data, outputs them to the user interface 124, and ends the present processing.

According to the present exemplary embodiment, with regard to individual regions to be printed therein with the transparent toner, a preview is displayed by changing display pattern according to the applied amount of the transparent toner. Accordingly, the user can grasp how much an amount of the transparent toner is printed in which region.

In the present exemplary embodiment, a display pattern is changed according to the applied amount of the transparent toner, with regard to respective regions to be printed therein with the transparent toner, by the following method. The original preview image is combined with a yellow rectangle for which a value has been set. As the applied amount of the transparent toner is larger, the smaller a value (the more opaque) is set.

However, the display pattern may be changed not only by the method but also by other methods. The original preview image is combined with, for example, a black rectangle for which a value has been set. As the applied amount of the transparent toner is large, the smaller a value is set. In this case, the controller unit 20 calculates a value by using the following formula (2)

α value=(255−minimum α value)/maximum value of applied amount ×applied amount+minimum α value (2)

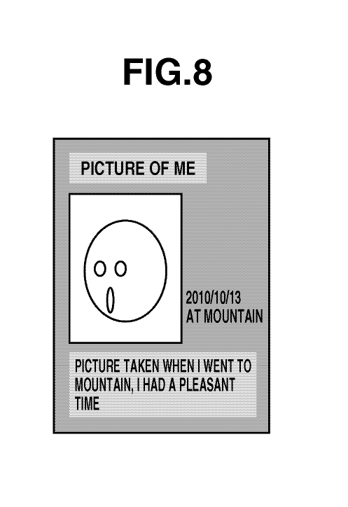

According to the above-described method, a transparent toner print setting preview 300b illustrated in FIG. 3 becomes as illustrated in FIG. 8. Further, the above-described colors are not limited to yellow/black but may be other colors, or may be configured to be selectable by the user. Furthermore, the display pattern may be changed not only by the change of display pattern by a combination, but also by other approaches, such as changing a luminance according to the applied amount of the transparent toner.

In the present exemplary embodiment, a method for providing a simpler operation unit, with regard to an applied amount setting of the transparent toner, will be described.

In an image forming apparatus such as a copying machine or a multifunction peripheral to which an image display apparatus can be applied, the image forming apparatus is usually equipped with a touch panel. A conventional touch panel is known of a single point input type, and single point at one time can be designated as an input.

However, in recent years, especially in devices such as mobile phones, touch panels serving as multi-point input type are becoming popular. In the present exemplary embodiment, an applied amount setting unit for transparent toner, in a case where the user interface 124 is equipped with the touch panel capable of performing multi-point input, will be described.

In the first exemplary embodiment described above, the user interface 124 and the controller unit 20 receive the designation of a region to be printed therein with the transparent toner of the transparent toner print setting preview (the designation of a region portion to be printed therein with the transparent toner in the screen 500d).

Then, the screen (the screen 500e) for setting an applied amount of the transparent toner is displayed. A user sets the applied amount of the transparent toner of the region by operating according to a display of this screen. In the present exemplary embodiment example, the applied amount of the transparent toner is set by simultaneously designating the two points, with respect to a region to be printed therein with the transparent toner.

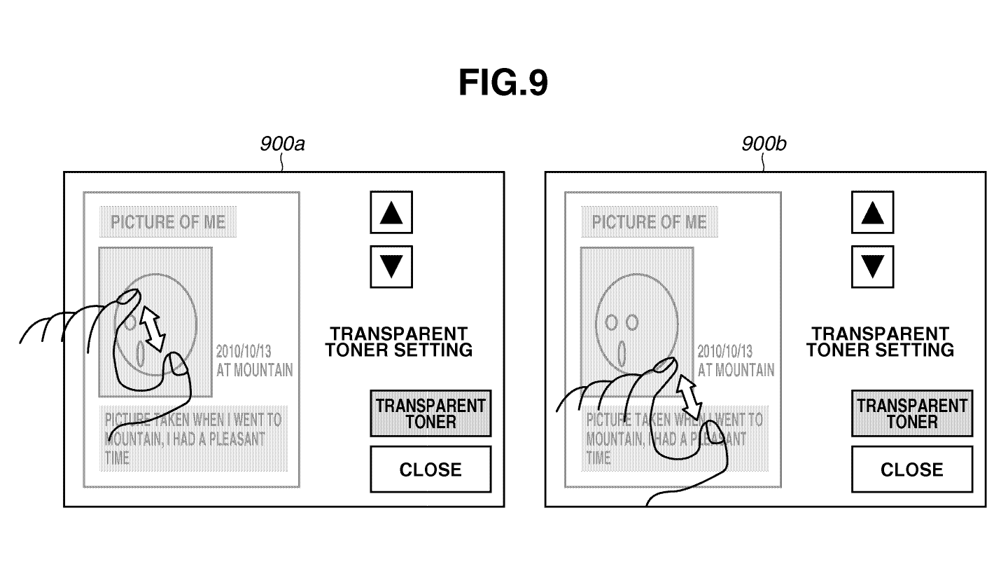

FIG. 9 illustrates an example of an operation screen displayed on the user interface 124 illustrated in FIG. 1. The present example is a user operation example associated with the transparent toner print setting.

In FIG. 9, as illustrated in a screen 900a, if the controller unit 20 determines that the two points which the user has simultaneously designated on the touch panel are both included in the identical region to be printed therein with the transparent toner, the applied amount of the transparent toner is changed with respect to only the region.

Then, if the user has performed an operation to reduce a distance between the two points designated by the user on the touch panel, the controller unit 20 decreases a applied amount of the transparent toner according to the distance. Further, if the user has performed an operation to increase a distance between the two points previously designated, the controller unit 20 increases the applied amount of the transparent toner according to the distance.

Further, as illustrated in a screen 900b, one point of the two points which the user has designated on the touch panel may be included in a region to be printed therein with the transparent toner, and another one point may be included in another region to be printed therein with the transparent toner.

In this case, the controller unit 20 changes the applied amount of the transparent toner, with respect to all regions to be printed therein with the transparent toner previously set using the user interface 124. Thereby, a display pattern of a region to be printed therein with the transparent toner is changed, and before actually printing an image, the user can recognize difference in gloss feel or irregularity feel of the image to be printed, and convenience is enhanced. Furthermore, the need to execute useless printing using the transparent toner is eliminated.

Further, even in a case where another one point, of the two points designated by the user on the touch panel, is also included in a portion not to be printed with the transparent toner, the controller unit 20 changes the applied amount of the transparent toner, with respect to all regions to be printed therein with the transparent toner previously set.

Furthermore, as illustrated in the screen 900b, in a case where a distance is reduced between the two points designated by the user on the touch panel, the controller unit 20 decreases the applied amount of the transparent toner according to the distance. Similarly, in a case where a distance is increased between the two points designated by the user on the touch panel, the controller unit 20 increases the applied amount of the transparent toner according to the distance.

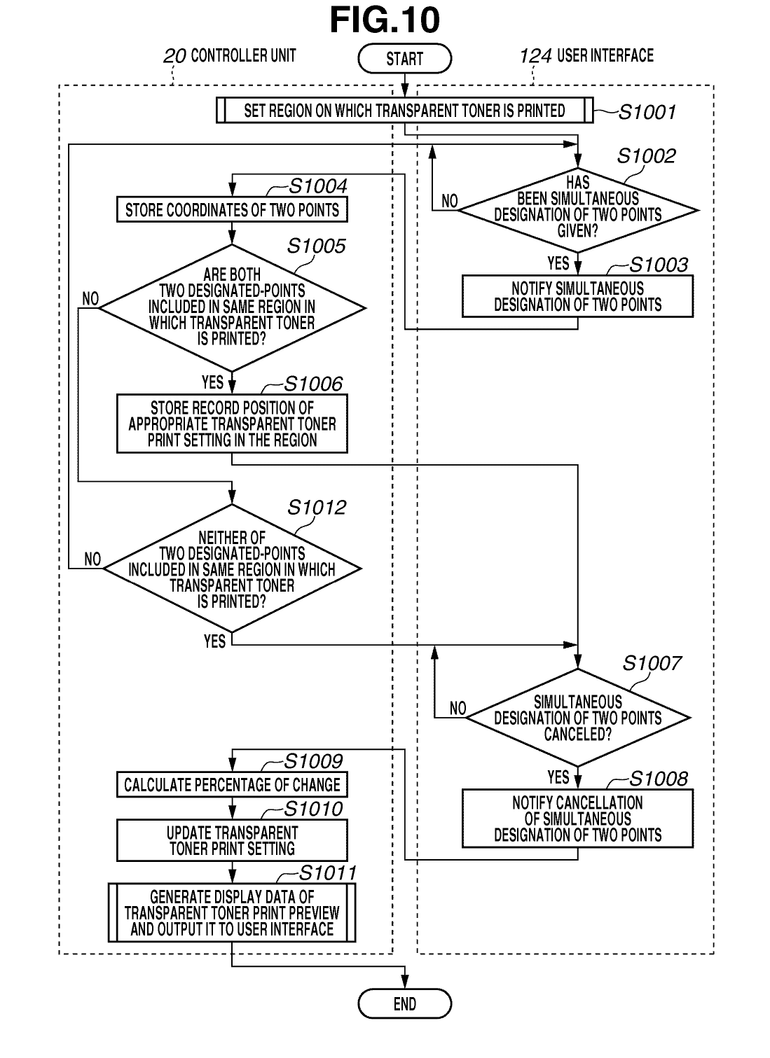

FIG. 10 is a flowchart illustrating a control procedure of the image display apparatus according to the present exemplary embodiment. The flowchart illustrates processing procedures of the controller unit 20 and the user interface 124 when the applied amount of the transparent toner is set. Respective steps are realized by loading a control program onto the direct storage unit 122 and executing it by the CPU 121 of the controller unit 20 illustrated in FIG. 1.

Hereinbelow, a print region display of transparent toner image which the printing device 11 prints by using the controller unit 20 and the user interface 124, will be described. In the present exemplary embodiment, the controller unit 20 receives a region to be printed therein with the transparent toner, and a transparent toner amount to be applied with the transparent toner to be set by the user using the user interface 124, and calculates a change amount of a rectangular region which the user will set later.

Further, the controller unit 20 determines whether a change state of the rectangular region as will be set later, which is set by using the user interface 124, can be included within the rectangular region previously set.

Then, if the controller unit 20 determines that the change state of the rectangular region is included within the rectangular region previously set, the controller unit 20 executes control as follows to change a preview display pattern of the image within the rectangular region previously set displayed on a display unit, by using the calculated change amount.

Further, if the controller unit 20 determines that the change state of the rectangular region is not included within the rectangular region previously set, the controller unit 20 executes control as follow to change preview display patterns of images within all rectangular regions previously set displayed on the display unit, by using the calculated change amount.

First, in step S1001, the controller unit 20 and the user interface 124 execute the processing illustrated in FIG. 6 to set a region to be printed therein with the transparent toner, and displays the display data of the transparent toner print preview image.

Next, in step S1002, the user interface 124 determines whether simultaneous designation of the points on the touch panel has been given by the user. If the user interface 124 determines that simultaneous designation of the two points on the touch panel has been given by the user (YES in step S1002), the processing proceeds to step S1003. If the user interface 124 determines that simultaneous designation of the two points on the touch panel has not been given, (NO in step S1002), the user interface 124 repeats the processing in step S1002.

Then, in step S1003, the user interface 124 notifies the controller unit 20 of the simultaneous designation of the two points. At this time, the user interface 124 notifies the controller unit 20 of the coordinates of the two points designated on the display data.

Then, in step S1004, the controller unit 20 stores on the direct storage unit 122 the coordinates of the two points notified from the user interface 124 in step 51003. Next, in step 51005, the controller unit 20 determines whether the designated two points are both included in the identical region to be printed therein with the transparent toner.

To this end, the controller unit 20 converts the coordinates of the two points into coordinates on the image. Then, the controller unit 20 determines whether each of the coordinates after conversion is included in the region data item 202 of the respective records of the transparent toner print setting 200. At this time, the controller unit 20 searches a region to be printed therein with the transparent toner that includes the coordinates and determines whether the region to be printed therein with the transparent toner is included in the region data item 202 of the respective records.

More specifically, the controller unit 20 compares the coordinates of the two points with the region data item 202, and determines whether the coordinates of the two points are included in the region data item 202 of the respective records of the transparent toner print setting 200.

Then, in step S1005, if the controller unit 20 determines that the coordinates of the two points are included in the region data item 202 of the respective records of the transparent toner print setting 200 (YES in step S1005), the processing proceeds to step S1006. If the controller unit 20 determines that the coordinates of the two points are not included in the region data item 202 (NO in step S1005), the processing proceeds to step S1012.

Then, in step S1006, the controller unit 20 stores on the direct storage unit 122 the position of the record of the transparent toner print setting 200 found in step S1005 (the region data item 202 of the record includes coordinates of the two points).

Then, in step S1007, the user interface 124 determines whether the simultaneous designation of the two points by the user has been canceled. If the user interface 124 determines that the simultaneous designation of the two points has been canceled (YES in step S1007), the processing proceeds to step S1008. If the user interface 124 determines that the simultaneous designation of the two points has not been canceled (NO in step S1007), the user interface 12 repeats the processing in step S1007.

In step S1008, the user interface 124 notifies the controller unit 20 of the cancellation of the simultaneous designation of the two points. At this time, the user interface 124 notifies the controller unit 20 of the coordinate data of the two points which had been designated until just before the simultaneous designation of the two points was canceled, on the display data.

Next, in step S1009, the controller unit 20 calculates a percentage of the change of the applied amount setting of the transparent tone. More specifically, the controller unit 20 calculates a distance between the two points (defined as a distance (1)), with regard to coordinates of the two points at the time of cancellation of the simultaneous designation of the two points notified from the user interface 124 in step S1008.

Further, the controller unit 20 calculates a distance between the two points (defined as a distance (2)), with regard to the coordinates of the two points stored in step S1004. Then, the controller unit 20 calculates a percentage of the change of a distance between the two points at the time of start and at the time of cancellation of the simultaneous designation of the two points, by dividing the distance (2) by the distance (1). Then, the controller unit 20 defines the percentage indicating the calculation results as the percentage of change of the applied amount setting of the transparent toner.

Next, in step S1010, the controller unit 20 updates the transparent toner print setting 200, based on a percentage of the change of the applied amount setting of the transparent toner calculated in step S1009. If the position of the record of the transparent toner print setting 200 is stored in step S1006, only a region to be printed therein with the transparent toner indicated by the record is a target of change.

Therefore, the controller unit 20 updates the applied amount data item 203 of the record with a value obtained by multiplying the original value by the percentage calculated in step S1009.

If the position of the record of the transparent toner print setting 200 is not stored in step S1006, all regions to be printed therein with the transparent toner are targets of change. Therefore, the controller unit 20 updates the applied amount data item 203 with a value obtained by multiplying the original value by the percentage calculated in step S1009, with regard to all records of the transparent toner print setting 200.

Then, in step S1011, the controller unit 20 executes the processing illustrated in FIG. 4 to generate the transparent toner applied amount preview image and its display data, outputs them to the user interface 124, and then ends the processing.

On the other hand, in step S1005, if the controller unit 20 determines that coordinates of the two points are not included in the identical region to be printed therein with the transparent toner (NO in step S1005), in step S1012, the controller unit 20 determines whether neither of the two points are included in any region to be printed therein with the transparent toner. More specifically, in step S1005, the controller unit 20 determines whether no corresponding record has not been found from the transparent toner print setting 200, with regard to the two points.

If the controller unit 20 determines that neither of the two points are included in any region to be printed therein with the transparent toner (NO in step S1012), the controller unit 20 returns the processing to step S1002. If the controller unit 20 determines that the two points are included in any region to be printed therein with the transparent toner (YES in step S1012), the controller unit 20 advances the processing to step S1007. According to the present exemplary embodiment, with regard to individual regions to be printed therein with the transparent toner, the applied amount of the transparent toner can be set by an easier operation method.

Aspects of the present invention can also be realized by a computer of a system or apparatus (or devices such as a CPU, a micro processing unit (MPU), and/or the like) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., a computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2010-279668 filed Dec. 15, 2010, which is hereby incorporated by reference herein in its entirety.

What is claimed is:

1. An image display apparatus comprising:
a display unit configured to display a preview of an image to be printed using a printing unit;
a setting unit configured to set a region in which the printing unit performs printing using transparent toner with respect to an image previewed on the display unit, and a transparent toner amount to be applied on the region; and
a control unit configured to change a preview display pattern of an image displayed on the display unit, using the region set by the setting unit and the transparent toner amount.

2. The image display apparatus according to claim 1, wherein the setting unit sets a region to be printed therein using the transparent toner as a rectangular region.

3. The image display apparatus according to claim 2, wherein the setting unit, by designating two different points on a preview screen displayed on the display unit, sets a region to be printed therein using the transparent toner as a rectangular region.

4. The image display apparatus according to claim 1, further comprising:
a calculation unit configured to calculate a change amount of a rectangular region to be set later by the setting unit; and
a determination unit configured to determine whether a change state of the rectangular region to be set later by the setting unit is included within the rectangular region previously set,
wherein the display unit, in a case where the determination unit determines that a change state of the rectangular region is included within a rectangular region previously set, changes a preview display pattern of an image within the rectangular region previously set displayed on the display unit, using the change amount calculated by the calculation unit, and
wherein the display unit, in a case where the determination unit determines that a change state of the rectangular region is not included within the rectangular region previously set, changes preview display patterns of all images to be displayed within the rectangular regions previously set, using the change amount calculated by the calculation unit.

5. A control method for controlling an image display apparatus, the method comprising:
displaying on a display unit a preview of an image to be printed using a printing unit;
setting a region in which the printing unit performs printing using transparent toner with respect to an image previewed on the display unit, and a transparent toner amount applied on the region; and
changing a preview display pattern of an image to be displayed on the display unit, using the set region to be printed therein with the transparent toner and the transparent toner amount.

6. A non-transitory computer readable storage medium for storing a computer program for controlling an image display unit, the program comprising:
a code to display on a display unit a preview of an image to be printed using a printing unit;
a code to set a region in which the printing unit performs printing using transparent toner with respect to an image previewed on the display unit, and a transparent toner amount to be applied on the region; and
a code to change a preview display pattern of an image to be displayed on the display unit, using the set region to be printed therein using the transparent toner and the transparent toner amount.
